(19) United States
(12) Patent Application Publication
(10) Pub. No.: US 2008/0162270 A1
(43) Pub. Date: Jul. 3, 2008

(54) METHOD AND SYSTEM FOR FORECASTING FUTURE ORDER REQUIREMENTS

(76) Inventors: Edward Kim, Toronto (CA); Jean-Philippe Vorsanger, Toronto (CA); Zhenrong Michael Li, Mississauga (CA); Ejaz Haider, Markham (CA)

Correspondence Address: JAMES M. STOVER;TERADATA CORPORATION, 2835 MIAMI VILLAGE DRIVE, MIAMISBURG, OH, 45342, US

(21) Appl. No.: 11/951,364

(22) Filed: Dec. 6, 2007

Related U.S. Application Data
(60) Provisional application No. 60/878,002, filed on Dec. 29, 2006.

(51) Int. Cl. G06Q 10/00

(52) U.S. Cl. 705/10

(57) ABSTRACT

A method and system for forecasting distribution center (DC) or warehouse product suggested order quantities required to meet future product demands for a retailer. In determining DC/warehouse order quantities, a bias factor and Adaptive Forecast Error (AFE) are calculated from prior product demand and sales data and applied to DC/warehouse effective inventory calculations to account for forecast errors in DC/warehouse suggested order quantities. If the bias indicates a forecast that is too high, the method and system will attempt to compensate by increasing the suggested order quantity. If the bias indicates a forecast that is too low, the method and system will attempt to compensate by decreasing the suggested order quantity.

### CROSS REFERENCE TO RELATED APPLICATIONS

This application claims priority under 35 U.S.C. §119(e) to the following co-pending patent application, which is incorporated herein by reference:

Provisional Application Ser. No. 60/878,002, entitled “IMPROVED METHOD AND SYSTEM FOR FORECASTING FUTURE ORDER REQUIREMENTS,” filed on Dec. 29, 2006, by Edward Kim, Jean-Philippe Vorsanger, Michael Li, and Ejaz Haider.

This application is related to the following co-pending and commonly-assigned patent applications, which are incorporated by reference herein:

Application Ser. No. 10/875,456, entitled “METHODS AND SYSTEMS FOR SYNCHRONIZING DISTRIBUTION CENTER AND WAREHOUSE DEMAND FORECASTS WITH RETAIL STORE DEMAND FORECASTS” by Edward Kim, Pat McDaid, Mardie Noble, and Fred Narduzzi; attorney docket number 11,545; filed on Jun. 24, 2004.

Application Ser. No. 10/737,056, entitled “METHODS AND SYSTEMS FOR FORECASTING FUTURE ORDER REQUIREMENTS” by Fred Narduzzi, David Chan, Blair Bishop, Richard Powell-Brown, Russell Sumiya and William Cortes; attorney docket number 11,332; filed on Dec. 16, 2003.

### FIELD OF THE INVENTION

The present invention relates to methods and systems for forecasting product demand for distribution center or warehouse operations; and in particular to a bias compensation system for improving the accuracy of distribution center/warehouse order forecasts.

### BACKGROUND OF THE INVENTION

Today's competitive business environment demands that retailers be more efficient in managing their inventory levels to reduce costs and yet fulfill demand. To accomplish this, many retailers are developing strong partnerships with their vendors/suppliers to set and deliver common goals. One of the key business objectives both the retailer and vendor are striving to meet is customer satisfaction by having the right merchandise in the right locations at the right time. To that effect it is important that vendor production and deliveries become more efficient. The inability of retailers and suppliers to synchronize the effective distribution of goods through the distribution facilities to the stores has been a major impediment to both maximizing productivity throughout the demand chain and effectively responding to the needs of the consumer.

In the past few years, improvements in technology have allowed businesses to take advantage of high volumes of detailed data in the development of accurate forecasted consumer demand patterns. The ability to predict this demand down to the level of store/SKU (Stock Keeping Unit)/day well out into the future now offers leading retailers the ability to synchronize distribution center/warehouse plans with store needs through an accurate demand forecast.

However, unlike product demand forecasts, distribution center/warehouse order forecasts have a tendency to be uneven or inconsistent since there are many non-linear factors or functions used to compute the order forecast. For instance, a high current inventory level may generate a small order amount, while a low inventory level will often generate a high order quantity. As a result of this non-linearity, order forecasts may erroneously continue a recent bias trend, and extend an over, or under, forecast into the long range order forecasts, possibly resulting in reduced order forecast accuracy, especially in the near term forecast horizon.

Described herein is a bias compensation scheme, part of the Teradata Demand Chain Management Order Forecast Optimizer (OFO) application, a product of NCR Corporation, which is used to more accurately model distribution center/warehouse order forecasts. These improved estimates can then be used in the planning process for more effective inventory management.

### BRIEF DESCRIPTION OF THE DRAWINGS

FIG. 1 provides an illustration of a forecasting, planning and replenishment software application suite for the retail industries built upon NCR Corporation's Teradata Data Warehouse.

FIG. 2 provides an illustration of a product supply/demand chain from a supplier and manufacturer to a retail store and customer.

FIG. 3 is a high level block diagram illustration of a process for determining DC/warehouse demand from a roll-up of store long range order forecasts.

FIG. 4 is process flow diagram illustrating a synchronized DC/warehouse forecasting and replenishment process.

FIG. 5 is a high level flow diagram of a process for calculating DC/warehouse suggested order quantities.

FIG. 6 is a graph providing a comparison between the relatively smooth product demand for a retail business and the “lumpy” demand seen by a distribution center and warehouse.

FIG. 7 is a high level flow diagram of a modified process for calculating DC/warehouse suggested order quantities in accordance with the present invention.

### DETAILED DESCRIPTION OF THE INVENTION

In the following description, reference is made to the accompanying drawings that form a part hereof and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

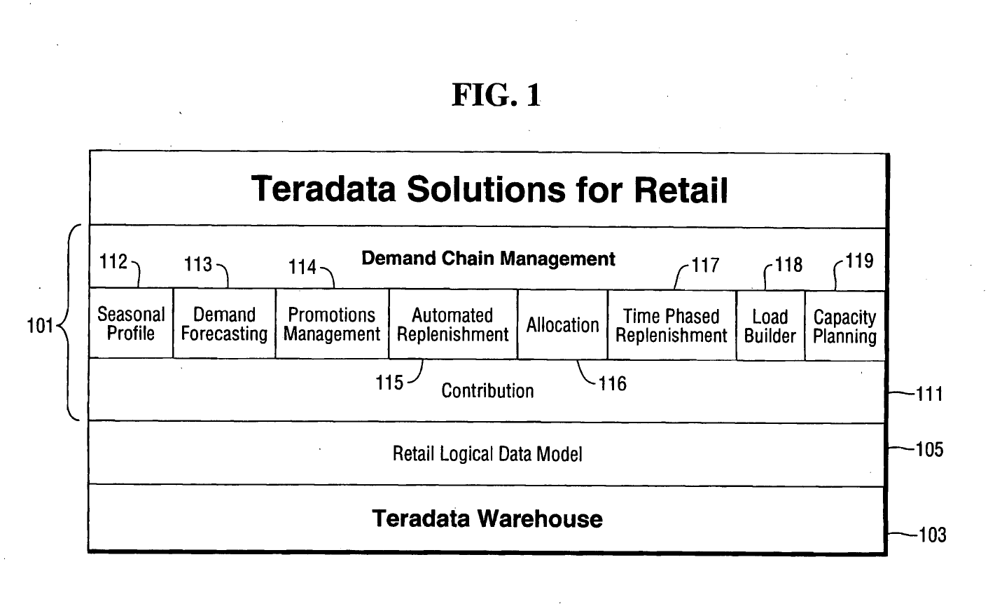

As illustrated in FIG. 1, the Teradata Demand Chain Management analytical application suite 101 is shown to be part of a data warehouse solution for the retail industries built upon NCR Corporation's Teradata Data Warehouse 103, using a Teradata Retail Logical Data Model (RLDM) 105. The key modules contained within the Teradata Demand Chain Management application suite 101, are:

Contribution: Contribution module 111 provides an automatic categorization of SKUs, merchandise categories and locations based on their contribution to the success of the business. These rankings are used by the replenishment system to ensure the service levels, replenishment rules and space allocation are constantly favoring those items preferred by the customer.

Seasonal Profile: The Seasonal Profile module 112 automatically calculates seasonal selling patterns at all levels of merchandise and location. This module draws on historical sales data to automatically create seasonal models for groups of items with similar seasonal patterns. The model might contain the effects of promotions, markdowns, and items with different seasonal tendencies.

Demand Forecasting: The Demand Forecasting module 113 provides store/SKU level forecasting that responds to unique local customer demand. This module considers both an item's seasonality and its rate of sales (sales trend) to generate an accurate forecast. The module continually compares historical and current demand data and utilizes several methods to determine the best product demand forecast.

Promotions Management: The Promotions Management module 114 automatically calculates the precise additional stock needed to meet demand resulting from promotional activity.

Automated Replenishment: Automated Replenishment module 115 provides the retailer with the ability to manage replenishment both at the distribution center and the store levels. The module provides suggested order quantities (SOQs) based on business policies, service levels, forecast error, risk stock, review times, and lead times.

Time Phased Replenishment: Time Phased Replenishment module 116 Provides a weekly long-range order forecast that can be shared with vendors to facilitate collaborative planning and order execution. Logistical and ordering constraints such as lead times, review times, service-level targets, min/max shelf levels, etc. can be simulated to improve the synchronization of ordering with individual store requirements.

Allocation: The Allocation module 115 uses intelligent forecasting methods to manage pre-allocation, purchase order and distribution center on-hand allocation.

Load Builder Load Builder module 118 optimizes the inventory deliveries coming from the distribution centers (DCs) and going to the retailer's stores. It enables the retailer to review and optimize planned loads.

Capacity Planning: Capacity Planning module 119 looks at the available throughput of a retailer's supply chain to identify when available capacity will be exceeded.

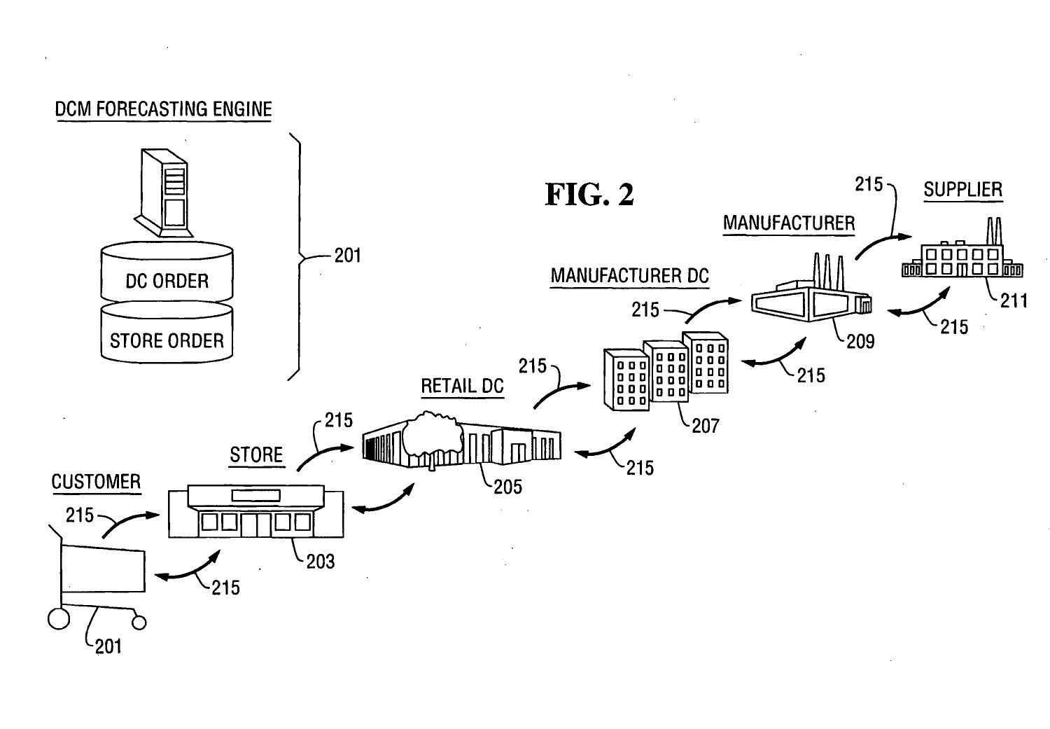

FIG. 2 provides an illustration of the retail demand/supply chain from a customer 101 to a retail store 103, retail distribution center/warehouse 105, manufacturer distribution center/warehouse 107, manufacturer 109 and supplier 111. In order to benefit from an efficient warehouse inventory system, retail businesses must synchronize the warehouse (DC/warehouse) replenishment system with the replenishment ordering system from their stores. The challenge here is to accurately translate the consumer demand from the stores to the distribution center (DC)/warehouse. Incorrect translations of the customer demand at the DC/warehouse will miscalculate inventory requirements resulting in stock-outs, over-stocks and inadequate service levels. These conditions cause businesses to incur higher inventory carrying costs, unnecessary markdowns and lost sales, eroding profits.

Thus, modeling and building a reliable Demand Chain Forecast is a significant step towards improved replenishment solutions and more efficient supply chains. The DC/warehouse demand leads the actual store consumer demand. This is to say the retail stores order products from the DC/warehouse in anticipation of consumer demand. Therefore the DC/warehouse forecast has to be able to look ahead further to create optimal vendor orders.

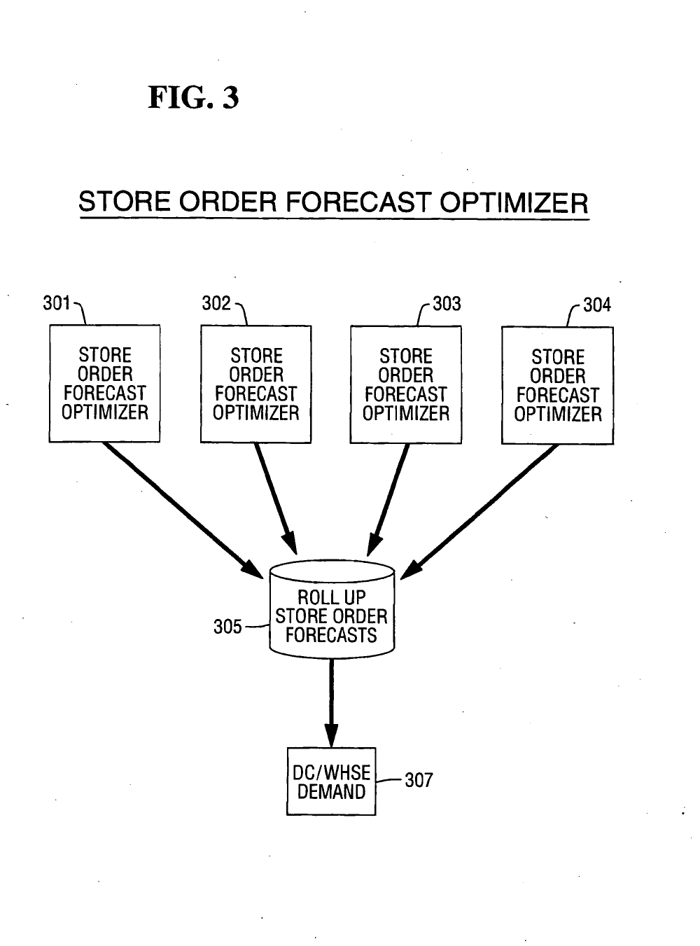

There are several methods that can be utilized to produce DC/warehouse demand forecasts. DC/warehouse demand forecasts can be determined from historical shipment data, from roll up of point-of-sale (POS) data, from roll up of Suggested Order Quantities (SOQs), or from store order forecasts as illustrated in FIG. 3.

FIG. 3 provides a high level illustration of a process wherein Store Order Forecasts determined for numerous retail stores 301-304 are accumulated 305 to generate a DC/warehouse demand value 307. Store Order Forecasts may be determined utilizing the Long Range Order Forecast system, also referred to herein as the Order Forecast Optimizer (OFO) system, described in application Ser. No. 10/737,056, referred to above and incorporated by reference herein. The DC/warehouse Replenishment Orders will be executed considering all stores' time-phased needs net of Effective Inventory and applying the DC/warehouse's Lead Time, Planned Sales Days, Forecast Error and Service Levels.

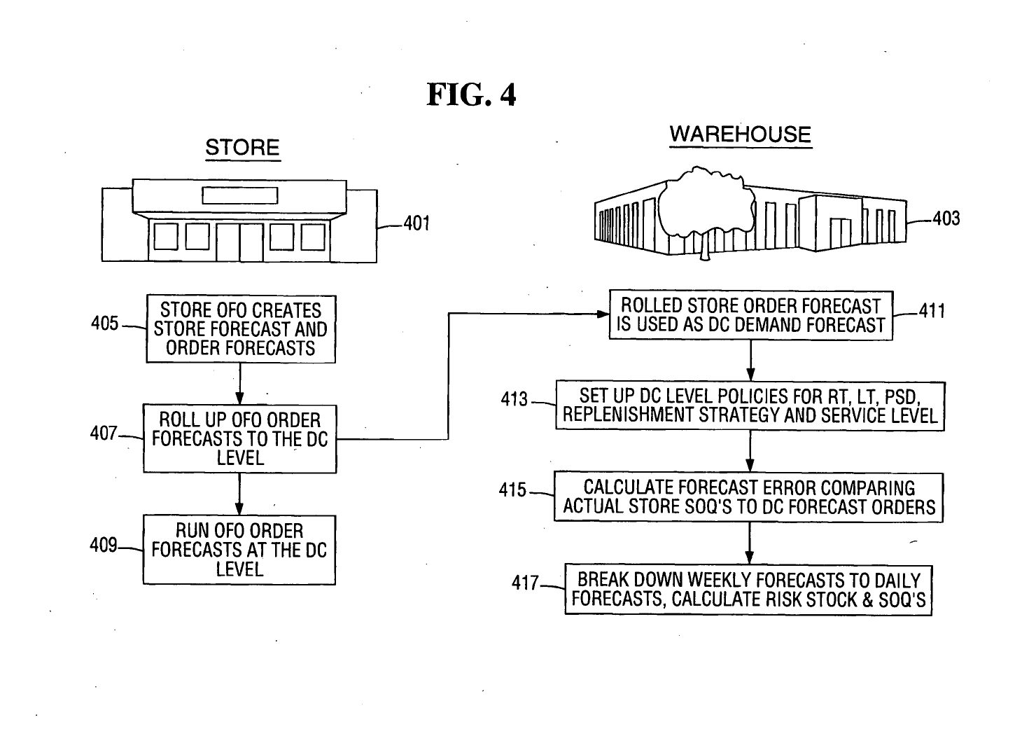

The process illustrated in FIG. 3 is employed within the synchronized DC/warehouse forecasting and replenishment process illustrated in the process flow diagram of FIG. 4. Beginning at step 405, each retail store 401 supplied by warehouse 403 creates a store forecast and order forecast. In step 407, the individual store OFO order forecasts are accumulated to the DC/warehouse level. This rolled-up OFO order forecast is provided to the DC/warehouse 403 for use as the DC/warehouse demand forecast, as shown in step 411.

In step 413, DC/warehouse level policies may be established for RT (Review Time from last time the replenishment system was run), LT (Lead Time from the order being cut to the delivery of product), PSD (Planned Sales Days, the amount of time the Effective Inventory should service the forecast demand), Replenishment Strategy, and Service Level. In step 415, forecast error is calculated comparing actual store Suggested Order Quantities (SOQs) to DC/warehouse forecast orders. Finally, in step 417, weekly forecasts are broken down to determine daily forecasts, calculate safety stock and SOQs. Safety Stock is the statistical risk stock needed to meet a certain service level for a given order quantity. The safety stock is a function of lead times, planned sales days, service level and forecast error.

The DC/warehouse forecasting and replenishment process illustrated in FIG. 4 is described in greater detail in application Ser. No. 10/875,456, referred to above and incorporated by reference herein.

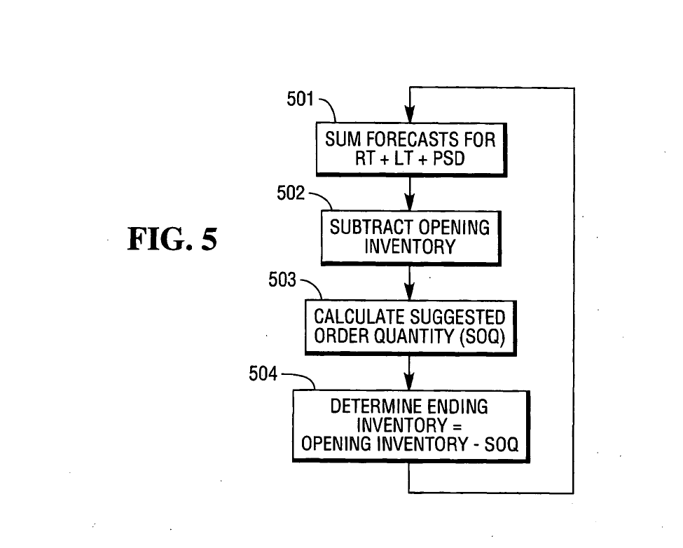

FIG. 5 is a high level flow diagram of the process for calculating DC/warehouse suggested order quantities (SOQs). In step 501 the forecasts for the Review Time (RT) period, Lead Time (LT) period, and Planned Sales Days (PSD) period are summed. In steps 502 and 503 the warehouse current, or opening, inventory is subtracted from the sum calculated in step 501 to determine the DC/warehouse suggested order quantity (SOQ). An ending inventory is calculated in step 504 by subtracting the suggested order quantity from the opening inventory.

The process is performed for each product of interest to the retailer, and repeated at regular intervals, e.g., weekly, to update product suggested order quantities. During the updates, the immediately prior determined ending inventory becomes the opening inventory for the update process.

Unlike demand forecasts, order forecasts have a tendency to be more “lumpy” since there are many non-linear factors (or functions) used to compute the order forecast. For instance, a high inventory level may generate a small order amount, while a low inventory level will often generate a high order quantity. As a result of this non-linearity, order forecasts may erroneously continue a recent bias trend, and extend an over, or under, forecast into the long range order forecasts. This may result in reduced order forecast accuracy especially in the near term forecast horizon.

In a system, such as the Teradata DCM Order Forecast Optimizer (OFO) system which typically executes weekly to calculate demand and order forecasts, a current weekly SOQ may vary greatly from the SOQ calculated for the same period in prior or subsequent executions. For example, if the OFO system is run on June 19^{th}, the SOQ calculation for the week of July 26^{th} may vary significantly from the SOQ calculated during the OFO execution on June 26^{th}.

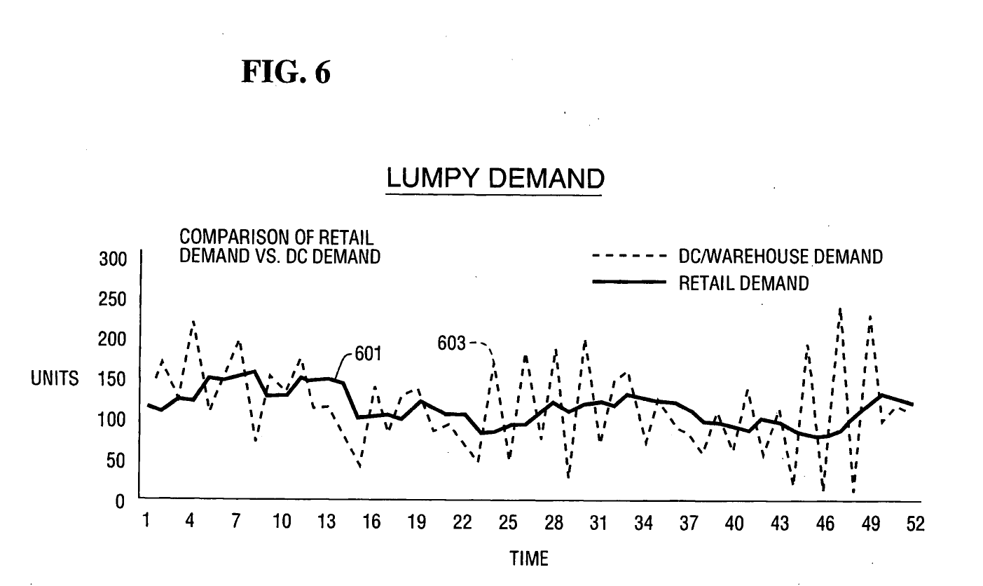

A comparison between a retail business' relatively smooth retail demand and the “lumpy” demand seen by the distribution center and warehouse is provided by the graph shown in FIG. 6. The graph displays along the y-axis, the demand for a high volume product (SKU) sold during a 52 week period, shown left to right on the x-axis. Retail demand for the product is shown by graph 601 and DC/warehouse demand is shown by graph 603.

### OFO Bias Compensation System

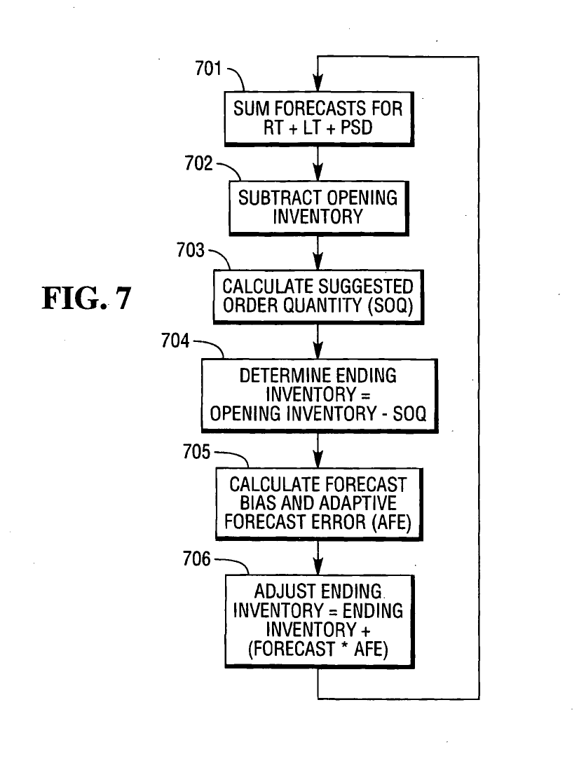

FIG. 7 is a high level flow diagram of a modified process for calculating DC/warehouse suggested order quantities, wherein a bias factor and Adaptive Forecast Error (AFE) are applied to effective inventory calculations to account for forecast errors in long range orders. If a forecast bias indicates an over-forecast, the inventory would run too high if bias were not applied. If the forecast bias indicates an under-forecast, the inventory would run too low if bias were not applied.

Steps 701 through 704 correspond to steps 501 through 504 of FIG. 5. In step 701 the forecasts for the Review Time (RT) period, Lead Time (LT) period, and Planned Sales Days (PSD) period are summed. In steps 702 and 703 the warehouse current, or opening, inventory is subtracted from the sum calculated in step 701 to determine the DC/warehouse suggested order quantity (SOQ). An ending inventory is calculated in step 704 by subtracting the suggested order quantity from the opening inventory. Bias and Adaptive Forecast Error (AFE) values are determined in step 705, and used to adjust the ending inventory value in step 706. Weekly suggested order quantity calculations are thereafter determined using the adjusted ending inventory as opening inventory.

In determining bias and AFE values, two bias values are calculated, a 52 week bias value and a blended bias value. The 52 week bias is calculated by subtracting 52 week demand from a 52 week forecast. This result is then divided by the 52 week forecast: Bias_{52wk}=(Forecast_{52wk}−Demand_{52wk})/Forecast_{52wk}. The bias value can be a positive or negative number.

Blended bias is based upon the bias calculated from the demand and forecast for the previous week. This would be the bias for week 1. However Bias is not applied until week 2. The Bias for week 2 blends the bias for week 1 with the 52 week Bias. Each subsequent week is blended with the previous week's bias: Bias_{wkn}=(Bias_{wkn-1}*(1−Response Factor))+(Bias_{52wk}*Response Factor)

The Adaptive Error Forecast is determined similarly to the blended bias: AFE_{wkn}=(AFE_{wkn-1}*(1−Response Factor))+(min(AFE_{52wk}, LIMIT of wk52AFE)*Response Factor). The 52 Week Adaptive Forecast Error, AFE_{52wk}, is the absolute value of the 52 week Bias. Current AFE comes from the forecast tables.

Once Bias and AFE have been calculated, the system determines how the AFE is used to adjust Ending Inventory. If the Bias is positive, this indicates a forecast that's too high, and thus an ending inventory that's too low. The system will attempt to compensate by increasing the SOQ. To reduce volatility, the ending inventory is increased by applying AFE to the forecast, thus reducing the SOQ: Ending Inventory=Ending Inventory+(Forecast*AFE).

If the Bias is negative, this indicates a forecast that's too low, and thus an ending inventory that's too high. The system will attempt to compensate by decreasing the SOQ. To reduce the volatility, the ending inventory is reduced by applying AFE to the forecast (expressed as a negative), thus increasing the SOQ: Ending Inventory=Ending Inventory−(Forecast*AFE).

The table below provides a summary of the various bias situations and the effects on suggested order quantities.

| Current Bias | 52 Week Bias | Effect |
|---|---|---|
| Positive | Positive | SOQ's are reduced by a factor that |
| | | decreases for each week. |
| Negative | Negative | SOQ's are increased by a factor that |
| | | decreases for each week. |
| Positive | Negative | SOQ's are reduced by a factor that |
| | | decreases each week until the blended |
| | | Bias becomes negative and then SOQ's |
| | | are increased by the same factor that |
| | | continues to decrease from week to week. |
| Negative | Positve | SOQ's are increased by a factor that |
| | | decreases each week until the blended |
| | | Bias becomes positive and then SOQ's are |
| | | decreased by the same factor that |
| | | continues to decreases from week to week. |

By applying the Bias and AFE, week to week fluctuations in SOQs should be reduced. It must be pointed out that the bias is applied to the weekly Effective Inventory calculations, not the weekly forecasts.

### CALCULATION EXAMPLES

The tables below illustrate the SOQ and ending inventory calculations for three weekly SOQ forecast periods. In the examples provided, Review Time (RT) period=1 week, Lead Time (LT) period=1 week, Planned Sales Days (PSD)=1 week, Week52_BIAS=−20%, Week52_AFE=20%, and the Response Factor=15%. The calculated bias, AFE, SOQ and inventory values shown in the tables have been rounded to two decimal places.

In Table 1, the week 2 (Dec. 19) SOQ is determined by summing the RT, LT, and PSD period forecasts and subtracting the opening inventory: SOQ=fcst(RT+LT+PSD)−OpenOH. As this is the first week where bias adjustments are determined, the opening inventory of 250 units has not been adjusted from the prior period ending inventory. Thus the SOQ=(120+140+170)−250=180 units. The unadjusted ending inventory=opening inventory+SOQ−the weekly forecast: 250+180−120=310 units. The adjusted ending inventory used for future SOQ calculations is determined by subtracting the (Forecast*AFE) from the unadjusted ending inventory is 327.51 units.

TABLE 1
December 19 SOQ Calculation

| | Week 1 | Week 2 | Week 3 | Week 4 | Week 5 | Week 6 | Week 7 |
|---|---|---|---|---|---|---|---|
| Run Date Dec. 19 | Dec. 19 | Dec. 26 | Jan 2 | Jan 9 | Jan. 16 | Jan. 23 | Jan. 30 |
| Previous Week | 100 | 120 | 140 | 170 | 120 | 100 | 80 |
| Forecast | | | | | | | |
| Previous Week | 88 | | | | | | |
| Demand | | | | | | | |
| This Week's BIAS | | 0.14 | | | | | |
| This Weeks | | 0.09 | | | | | |
| Blended BIAS | | | | | | | |
| This Week's AFE | | 0.14 | | | | | |
| This Weeks | | 0.15 | | | | | |
| Blended AFE | | | | | | | |
| Opening OH | | 250.00 | | | | | |
| SOQ | | 180.00 | | | | | |
| Ending OH | | 327.51 | | | | | |

In Table 2, the week 2 (Dec. 26) SOQ is again determined by summing the RT, LT, and PSD period forecasts and subtracting the opening inventory, however, the opening inventory is 327.51, the adjusted ending inventory from Table 1. The week 2 (Dec. 26) SOQ=SOQ=(140+170+120)=327.51, and the adjusted ending inventory is 311.56 units.

TABLE 2
December 26 SOQ Calculation

| | Week 1 | Week 2 | Week 3 | Week 4 | Week 5 | Week 6 | Week 7 |
|---|---|---|---|---|---|---|---|
| Run Date Dec. 26 | Dec. 26 | Jan 2 | Jan 9 | Jan. 16 | Jan. 23 | Jan. 30 | Feb. 7 |
| Previous Week | 120 | 140 | 170 | 120 | 100 | 80 | 90 |
| Forecast | | | | | | | |
| Pervious Week | | | | | | | |
| Demand | | | | | | | |
| Last Week's BIAS | | 0.09 | | | | | |
| This Weeks | | 0.04 | | | | | |
| Blended BIAS | | | | | | | |
| Last Week's AFE | | 0.15 | | | | | |
| This Weeks | | 0.15 | | | | | |
| Blended AFE | | | | | | | |
| Opening OH | | 327.51 | | | | | |
| SOQ | | 102.49 | | | | | |
| Ending OH | | 311.56 | | | | | |

In Table 3, the week 2 (Jan. 2) SOQ is again determined by summing the RT, LT, and PSD period forecasts and subtracting the opening inventory of 311.56 units, the adjusted ending inventory from Table 2. The week 2 (Jan. 2) SOQ=SOQ=(170+120+100)−311.56=78.44 units, and the adjusted ending inventory is 247.36 units.

TABLE 3
January 2 SOQ Calculation

| | Week 1 | Week 2 | Week 3 | Week 4 | Week 5 | Week 6 | Week 8 |
|---|---|---|---|---|---|---|---|
| Run Date Jan. 2 | Jan 2 | Jan 9 | Jan. 16 | Jan. 23 | Jan. 30 | Feb. 7 | Feb. 7 |
| Previous Week | 140 | 170 | 120 | 100 | 80 | 90 | |
| Forecast | | | | | | | |
| Pervious Week | | | | | | | |
| Demand | | | | | | | |
| Last Week's BIAS | | 0.04 | | | | | |
| This Weeks | | 0.01 | | | | | |
| Blended BIAS | | | | | | | |
| Last Week's AFE | | 0.15 | | | | | |
| This Weeks | | 0.16 | | | | | |
| Blended AFE | | | | | | | |
| Opening OH | | 311.56 | | | | | |
| SOQ | | 78.44 | | | | | |
| Ending OH | | 247.36 | | | | | |

### CONCLUSION

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A method for forecasting warehouse product order quantities required to meet future product demands for a retailer, the method comprising the steps of:
maintaining a database of historical product demand information;
determining a demand forecast for a product from said historical product demand information;
comparing said demand forecast with an inventory level of said product at said warehouse to determine a suggested order quantity for said product to meet future demand for said product;
adjusting said inventory level to accommodate for variances in prior suggested order quantity determinations for said product; and
utilizing said adjusted inventory level in a subsequent determination of a suggested order quantity for said product.

2. The method in accordance with claim 1, wherein said step of adjusting said inventory level to accommodate for variances in prior suggested order quantity determinations for said product comprises the steps of:
determining a bias compensation value from analysis of prior demand forecasts for said product and prior sales for said product; and
adjusting said inventory level by the product of said demand forecast and said bias compensation value.

3. The method in accordance with claim 2, wherein:
said bias compensation value comprises |(prior demand forecast−prior sales)/prior demand forecast|; and
said adjusted ending inventory=unadjusted ending inventory±(current demand forecast*bias compensation value).

4. The method in accordance with claim 1, wherein said demand forecast and suggested order quantity are calculated at weekly intervals.

5. A method for forecasting warehouse product order quantities required to meet future product demands for a retailer, the method comprising the steps of:
a) maintaining a database of historical product demand information;
b) determining a demand forecast for a product from said historical product demand information;
c) comparing said demand forecast with an opening inventory level of said product at said warehouse to determine a suggested order quantity for said product to meet future demand for said product;
d) determining an ending inventory level of said product from said opening inventory level, said suggested order quantity and said demand forecast;
e) adjusting said ending inventory level to accommodate for variances in prior suggested order quantity determinations for said product; and
f) repeating steps a) through e) at weekly intervals utilizing said adjusted ending inventory level as said opening inventory level in said determination of a suggested order quantity for said product.

6. A method for forecasting warehouse product order quantities required to meet future product demands for a retailer, the method comprising the steps of:
a) maintaining a database of historical product demand information;
b) determining a plurality of consecutive weekly demand forecasts for a product from said historical product demand information, said plurality of weekly demand forecasts including a current week demand forecast;
c) comparing said current week demand forecast and a selected number of succeeding weekly demand forecasts with an opening inventory level of said product at said warehouse to determine a suggested order quantity for said product to meet future demand for said product;
d) determining an ending inventory level of said product from said opening inventory level, said suggested order quantity and said current week demand forecast;
e) adjusting said ending inventory level to accommodate for variances in prior suggested order quantity determinations for said product; and
f) repeating steps a) through e) at weekly intervals utilizing said adjusted ending inventory level as said opening inventory level in said determination of a suggested order quantity for said product.

7. The method in accordance with claim 6, wherein said selected number of succeeding weekly demand forecasts span a period of time necessary to fulfill a product order from said warehouse.

8. The method in accordance with claim 6, wherein said step of adjusting said inventory level to accommodate for variances in prior suggested order quantity determinations for said product comprises the steps of:
determining a bias compensation value from analysis of prior weekly demand forecasts for said product and prior weekly sales for said product; and
adjusting said inventory level by the product of said current week demand forecast and said bias compensation value.

9. The method in accordance with claim 8, wherein:
said bias compensation value comprises |(prior weekly demand forecast−prior weekly sales)/prior week demand forecast|; and
said adjusted ending inventory=unadjusted ending inventory±(current week demand forecast*bias compensation value).

10. A system for forecasting product order quantities required to meet future product demands for a retail distribution center, the system comprising:
a database of historical product demand information;
means for determining a future demand forecast for a product from said historical product demand information;
means for comparing said future demand forecast with an inventory level of said product at said distribution center to determine a suggested order quantity for said product to meet future demand for said product;
means for adjusting said inventory level to accommodate for variances in prior suggested order quantity determinations for said product; and
means for utilizing said adjusted inventory level in a subsequent determination of a suggested order quantity for said product.
